(19) United States
(12) Patent Application Publication
(10) Pub. No.: US 2019/0056231 A1
(43) Pub. Date: Feb. 21, 2019

(54) METHOD AND APPARATUS FOR PARTICIPATIVE MAP ANOMALY DETECTION AND CORRECTION

(71) Applicant: GM GLOBAL TECHNOLOGY OPERATIONS LLC, Detroit, MI (US)

(72) Inventors: Fan Bai, Ann Arbor, MI (US); Donald K. Grimm, Utica, MI (US); Robert A. Bordo, Harrison Township, MI (US); David E. Bojanowski, Clarkston, MI (US)

(73) Assignee: GM GLOBAL TECHNOLOGY OPERATIONS LLC, Detroit, MI (US)

(21) Appl. No.: 15/677,455

(22) Filed: Aug. 15, 2017

(51) Int. Cl. G01C 21/30; G01S 19/45

(52) U.S. Cl. CPC G01C 21/30; G06F 17/30867; G01S 19/45

(57) ABSTRACT

Systems and method are provided for participative map anomaly detection and correction. In one embodiment, a processor-implemented method for map anomaly detection is provided. The method includes receiving, by a processor in a vehicle, pre-planned trajectory data from a navigation module in the vehicle, retrieving, by the processor, sensor data from one or more vehicle sensing systems, analyzing, by the processor, the sensor data and the pre-planned trajectory data, identifying, by the processor, an anomaly from the analysis, and transmitting information regarding the anomaly to a central repository external to the vehicle wherein the central repository is configured to analyze the information regarding the anomaly to determine if a navigation map attribute is incorrect.

### TECHNICAL FIELD

The present disclosure generally relates to navigational applications, and more particularly relates to systems and methods for dynamically identifying discrepancies in mapping data used by navigational applications.

### BACKGROUND

Navigational applications are widely used in entities such as manually driven vehicles, autonomous vehicles, and mobile devices as navigational aids for directing a user from one point to another. The navigational applications rely on mapping data that was gathered sometime in the past. The mapping data may not always reflect the actual environment it is intended to depict. The mapping data may contain errors or become stale due to environmental changes such as road construction.

The entities that use navigational applications often have various sensors that may be used to sense the actual environment. For example, vehicles may be equipped with perception systems containing sensing devices such as radar, lidar, image sensors, and others. The perception systems and other sensing systems may be available to provide sensing data for use in verifying the accuracy of mapping data utilized by navigational applications.

Accordingly, it is desirable to provide systems and methods for utilizing sensor data collected by entities that use navigational applications to identify discrepancies in mapping data. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for participative map anomaly detection and correction. In one embodiment, a processor-implemented method for map anomaly detection is provided. The method includes receiving, by a processor in a vehicle, pre-planned trajectory data from a navigation module in the vehicle, retrieving, by the processor, sensor data from one or more vehicle sensing systems, analyzing, by the processor, the sensor data and the pre-planned trajectory data, identifying, by the processor, an anomaly from the analysis, and transmitting information regarding the anomaly to a central repository external to the vehicle wherein the central repository is configured to analyze the information regarding the anomaly to determine if a navigation map attribute is incorrect.

In one embodiment, the sensor data includes vehicle performance data, vehicle perception data, and vehicle position data.

In one embodiment, the vehicle performance data is retrieved from controller area network (CAN) signals, the vehicle perception data is retrieved from a radar sensor, a lidar sensor, or a camera, and the vehicle position data is retrieved from GPS data.

In one embodiment, the vehicle performance data includes vehicle velocity data, vehicle acceleration data, and vehicle yaw data.

In one embodiment, analyzing the sensor data and the pre-planned trajectory data includes determining actual vehicle trajectory data from the sensor data and comparing the actual trajectory data with the pre-planned trajectory data.

In one embodiment, identifying an anomaly from the analysis includes identifying a sudden lane change, a sudden road exit, or driving in the wrong direction on a map pathway.

In one embodiment, analyzing the sensor data and the pre-planned trajectory data includes comparing, in the navigation module, actual vehicle travel with the pre-planned trajectory data.

In one embodiment, identifying an anomaly from the analysis includes receiving a notification from the navigation module that the vehicle deviated from a navigation maneuver instruction provided by the navigation module.

In one embodiment, analyzing the sensor data and the pre-planned trajectory data includes comparing map data that identifies a structural feature on a pre-planned vehicle path with perception data for an actual area at which the structural feature is expected to exist.

In one embodiment, identifying an anomaly from the analysis includes identifying a disagreement between the map data and the perception data regarding the existence of the structural feature.

In one embodiment, analyzing the sensor data and the pre-planned trajectory data includes applying a filter with a tolerance threshold for classifying changes in the sensor data.

In one embodiment, identifying an anomaly from the analysis includes identifying a sudden change in the sensor data that exceeds the tolerance threshold.

In one embodiment, analyzing the sensor data and the pre-planned trajectory data includes applying a filter that includes a correlation function for the sensor data.

In one embodiment, identifying an anomaly from the analysis includes identifying an instance when the correlation between the sensor data deviates beyond a predetermined level.

In one embodiment, analyzing the sensor data and the pre-planned trajectory data includes comparing actual vehicle behavior as determined by the sensor data and expected vehicle behavior based on the pre-planned trajectory data.

In another embodiment, a system for determining digital map discrepancies is provided. The system includes a discrepancy detector module that includes one or more processors configured by programming instructions encoded in non-transient computer readable media. The discrepancy detector module is configured to store anomaly information received from a plurality of insight modules in a central repository, wherein each insight module is located in a different vehicle remote from the discrepancy detector module. Each insight module includes one or more processors configured by programming instructions encoded in non-transient computer readable media. Each insight module is configured to identify a map anomaly by comparing map data from a navigation module to vehicle sensor data. The discrepancy detector module is configured to analyze the anomaly information from the plurality of insight modules to determine if a reported anomaly resulted from a discrepancy in digital map data.

In one embodiment, the discrepancy detector module includes an event ingestion module that is configured to manage the receipt of anomaly messages from the event insight modules so that complete messages are received and store the received anomaly messages in a relational database in the central repository wherein the received anomaly messages are organized by type of anomaly and location at which the anomaly occurred.

In one embodiment, the discrepancy detector module includes one or more map discrepancy determination modules that include one or more of a concatenated rule synthesis based determination module, a support vector machine (SVM) descriptor and detector based determination module, and a deep learning neural network and convolutional neural network based determination module.

In one embodiment, the discrepancy detector module is further configured to request additional data for use in determining if a reported anomaly resulted from a discrepancy in digital map data by establishing an extended reinforcement learning area wherein each vehicle located in the extended reinforcement learning area that is equipped with an event insight module is directed to report planned trajectory information, actual trajectory information, and sensor data to the discrepancy detector module.

In another embodiment, a system for determining digital map discrepancies is provided. The system includes a plurality of insight modules that include one or more processors configured by programming instructions encoded in non-transient computer readable media. Each insight module is located in a different vehicle. Each insight module is configured to receive pre-planned trajectory data from a navigation module in its vehicle, retrieve sensor data from one or more vehicle sensing systems, analyze the sensor data and the pre-planned trajectory data, identify an anomaly from the analysis, and transmit information regarding the anomaly to a central repository external to the vehicle. The system further includes a discrepancy detector module located remotely from the plurality of insight modules. The discrepancy detector module includes one or more processors configured by programming instructions encoded in non-transient computer readable media. The discrepancy detector module is configured to store anomaly information received from the plurality of insight modules in the central repository and analyze the anomaly information from the plurality of insight modules to determine if a reported anomaly resulted from a discrepancy in digital map data.

### DESCRIPTION OF THE DRAWINGS

The exemplary embodiments will hereinafter be described in conjunction with the following drawing figures, wherein like numerals denote like elements, and wherein:

FIG. 1 is a block diagram depicting an example system in which a map discrepancy detection and correction system may be implemented, in accordance with various embodiments;

FIG. 2 is a block diagram of an example vehicle that may employ both a navigational module and an insight module, in accordance with various embodiments;

FIG. 3 is a block diagram depicting example components of an example map discrepancy detection and correction system, in accordance with various embodiments;

FIG. 4 presents a top-down view of an example scenario useful in understanding the present subject matter, in accordance with various embodiments; and

FIG. 5 is a process flow chart depicting an example process in a vehicle for identifying an anomaly that may result from a map data discrepancy, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

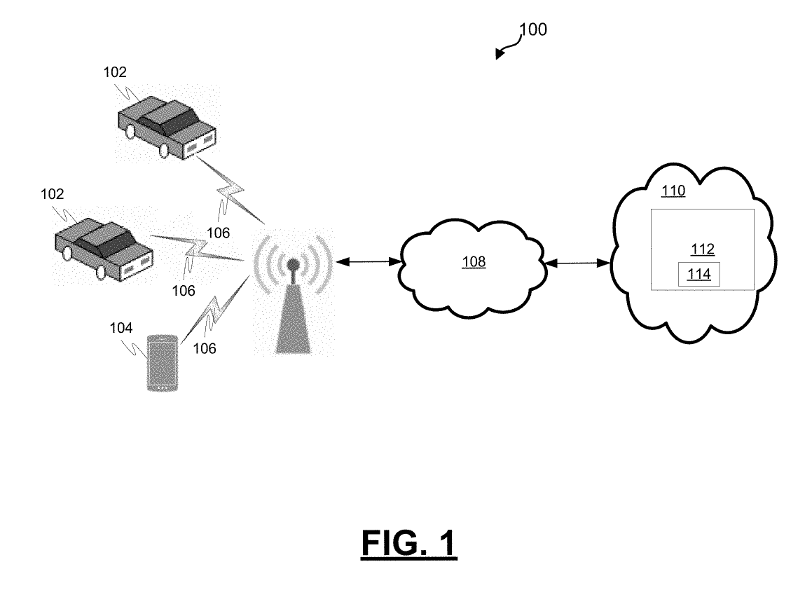

FIG. 1 is a block diagram depicting an example system 100 in which a map discrepancy detection and correction system may be implemented. The example map discrepancy detection and correction system may, in real-time or near real-time, detect a discrepancy in mapping data and, in some examples, may provide a proposed correction for the mapping data.

The example system 100 includes various entities such as vehicles 102 and a mobile device 104 carried by a pedestrian that may use a navigational application (not shown) to obtain travel directions. The navigational application may utilize various types of data such as road topology and road attributes data, road geometry data, navigation guidance data, and addressing and post office information (POI) to perform its functions.

The road topology and road attributes data may include data regarding road connectivity, road type/functional road class, turn and turn restrictions, intersection, traffic sign regulators, speed limit, road properties (e.g., pavement, divided, scenic, and others), and other similar types of data. The road geometry data may include data regarding road segment geometry, road segment heading, road curvature, road slope/grade, bank angle/road tilt, and other similar types of data. The navigation guidance data may include data regarding traffic regulator sign, traffic regulator location, extended lane info, number of lanes, lane type, lane merge/lane split, lane marking, lane annotation, lane rule/guidance, natural guidance, and other similar types of data. The addressing and POIs data may include data regarding home/work address, important frequent visits, core POIs (e.g., commercial POIs), parking/toll/gas stations, and other similar types of data.

The navigational application enabled entities 102, 104 may communicate with a backend server 112 containing a server-based map discrepancy detection and correction application 114, for example, via a cellular communication channel 106 over a cellular network such as 4G LTE or 4G LTE-V2X, a public network 108, and a private network 110. The example entities 102, 104 include an insight application (not shown) for communicating with the server-based application 114.

An insight application in an example entity 102, 104 may identify an anomaly related to map data during operation of a navigational application and communicate the anomaly to the cloud-based application 114. The cloud-based application 114 may investigate the anomaly to determine if a discrepancy in map data utilized by the navigational applications indeed exists, determine the nature of the discrepancy, and propose a correction to the map data. The example cloud-based application 114 is configured to receive sensor data from the insight application in the anomaly reporting entity 112, 114, may direct the insight application to provide additional sensor data, and may direct entities (e.g., vehicles) in the vicinity of a reported anomaly to provide sensor data that may be used to further evaluate the anomaly.

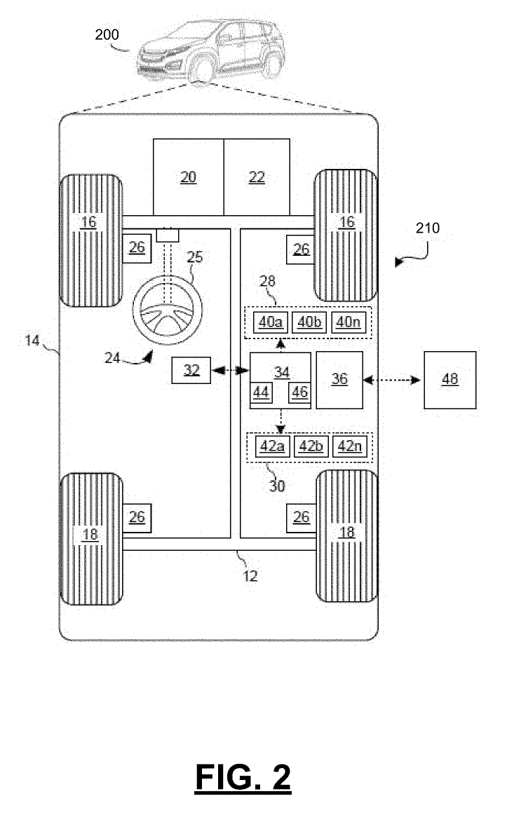

FIG. 2 is a block diagram of an example vehicle 200 that may employ both a navigational module and an insight module. The example vehicle 200 generally includes a chassis 12, a body 14, front wheels 16, and rear wheels 18. The body 14 is arranged on the chassis 12 and substantially encloses components of the vehicle 200. The body 14 and the chassis 12 may jointly form a frame. The wheels 16-18 are each rotationally coupled to the chassis 12 near a respective corner of the body 14.

The example vehicle 200 may be an autonomous vehicle (e.g., a vehicle that is automatically controlled to carry passengers from one location to another), a semi-autonomous vehicle or a passenger-driven vehicle. In any case, an insight application 210 is incorporated into the example vehicle 200. The example vehicle 200 is depicted as a passenger car but may also be another vehicle type such as a motorcycle, truck, sport utility vehicle (SUV), recreational vehicles (RV), marine vessel, aircraft, etc.

The example vehicle 200 includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 200 (such as the state of one or more occupants) and generate sensor data relating thereto. Sensing devices 40a-40n might include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter.

The actuator system 30 includes one or more actuator devices 42a-42n that control one or more vehicle features such as, but not limited to, the propulsion system 20, the transmission system 22, the steering system 24, and the brake system 26. In various embodiments, vehicle 200 may also include interior and/or exterior vehicle features not illustrated in FIG. 2, such as various doors, a trunk, and cabin features such as air, music, lighting, touch-screen display components (such as those used in connection with navigation systems), and the like.

The data storage device 32 stores data for use in the vehicle 200. In various embodiments, the data storage device 32 stores defined maps of the navigable environment. In various embodiments, the defined maps may be predefined by and obtained from a remote system. For example, the defined maps may be assembled by the remote system and communicated to the vehicle 200 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 200. In various embodiments, controller 34 is configured to implement an insight module as discussed in detail below.

The controller 34 may implement a navigational module and an insight module. That is, suitable software and/or hardware components of controller 34 (e.g., processor 44 and computer-readable storage device 46) are utilized to provide a navigational module and an insight module that is used in conjunction with vehicle 200.

The instructions may include one or more separate programs, each of which comprises an ordered listing of executable instructions for implementing logical functions. The instructions, when executed by the processor 44, receive and process signals (e.g., sensor data) from the sensor system 28, perform logic, calculations, methods and/or algorithms for controlling the components of the vehicle 200, and generate control signals that are transmitted to the actuator system 30 to automatically control the components of the vehicle 200 based on the logic, calculations, methods, and/or algorithms. Although only one controller 34 is shown in FIG. 2, embodiments of the vehicle 200 may include any number of controllers 34 that communicate over a suitable communication medium or a combination of communication mediums and that cooperate to process the sensor signals, perform logic, calculations, methods, and/or algorithms, and generate control signals to automatically control features of the vehicle 200.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle 200 may also include a perception system and a positioning system. The perception system synthesizes and processes the acquired sensor data and predicts the presence, location, classification, and/or path of objects and features of the environment of the vehicle 200. In various embodiments, the perception system can incorporate information from multiple sensors (e.g., sensor system 28), including but not limited to cameras, lidars, radars, and/or any number of other types of sensors.

The positioning system processes sensor data along with other data to determine a position (e.g., a local position relative to a map, an exact position relative to a lane of a road, a vehicle heading, etc.) of the vehicle 200 relative to the environment. As can be appreciated, a variety of techniques may be employed to accomplish this localization, including, for example, simultaneous localization and mapping (SLAM), particle filters, Kalman filters, Bayesian filters, and the like.

In various embodiments, the controller 34 implements machine learning techniques to assist the functionality of the controller 34, such as feature detection/classification, obstruction mitigation, route traversal, mapping, sensor integration, ground-truth determination, and the like.

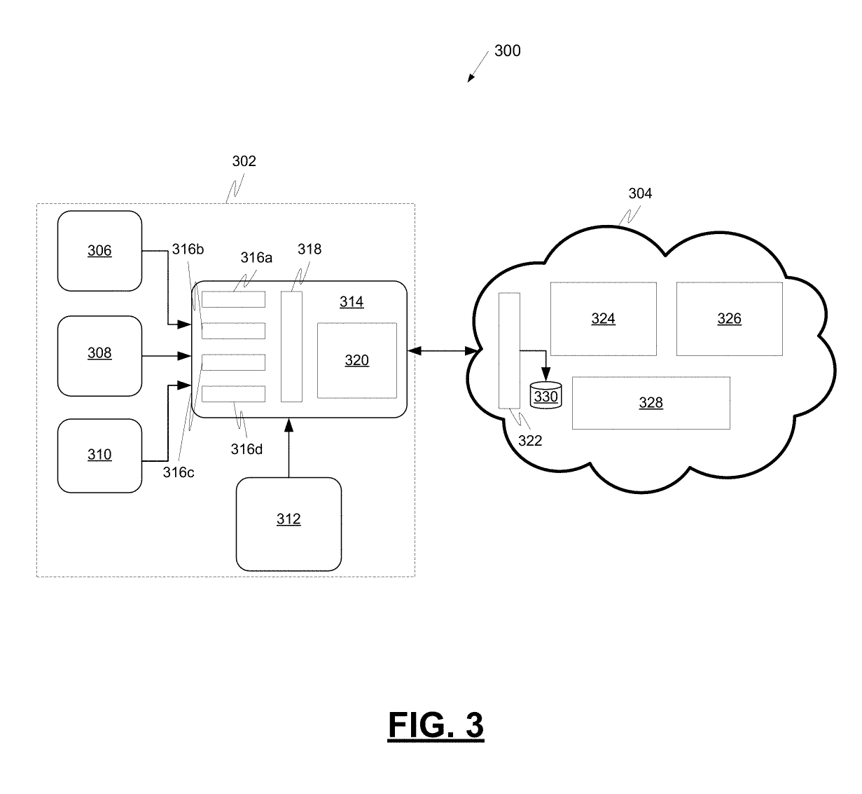

FIG. 3 is a block diagram depicting example components of an example map discrepancy detection and correction system 300. The example system includes one or more vehicles 302 and a computer-implemented map discrepancy detector 304.

An example vehicle 302 includes a position determination module 306, which may utilize a GPS sensor, and a controller area network (CAN) 308 over which various vehicle controllers may communicate messages containing, for example, vehicle performance data, such as velocity, acceleration, and yaw. The example vehicle 302 may also include a variety of perception sensors 310 such as a lidar, radar, and camera. The example vehicle 302 includes a navigational module 312 and an event insight module 314 that is configured to identify an anomaly related to map data during operation of the navigational module 312 and communicate the anomaly to the map discrepancy detector 304.

The example event insight module 314 is configured to retrieve pre-planned trajectory data from the navigation module 312 and sensor data (e.g., 316a, 316b, 316c, 316d) from one or more vehicle sensing systems. In this example, the sensor data comprises vehicle performance data, vehicle perception data, and vehicle position data. The example vehicle perception data is retrieved from perception sensors (e.g., radar, lidar, camera), the example vehicle position data is retrieved from the position determination module 306 as GPS data 316a, and the example vehicle performance data is retrieved from messages on the CAN 308. The example vehicle performance data comprises vehicle velocity data 316b, vehicle acceleration data 316c, and vehicle yaw data 316d.

The example event insight module 314 is configured to analyze the sensor data and the pre-planned trajectory data and identify an anomaly with respect to map data from the analysis. The example event insight module 314 may be configured to identify an anomaly from unnatural driving behaviors, from disobeyed navigation maneuver instructions, contradictions between map and sensor data, and others. The example event insight module 314 may be configured to perform a number of different analysis and identification operations to identify an anomaly.

In one example, the event insight module 314 is configured to analyze the vehicle sensing data and the pre-planned trajectory data by comparing actual vehicle behavior as determined by the vehicle sensing data to expected vehicle behavior based on the pre-planned trajectory data. In this example, the event insight module 314 may be further configured to identify an anomaly from the analysis by identifying a discrepancy between actual vehicle behavior as determined by the vehicle sensing data and expected vehicle behavior based on the path planning data.

In another example, the event insight module 314 is configured to analyze the vehicle sensing data and the pre-planned trajectory data by determining actual vehicle trajectory data from the sensor data and comparing the actual trajectory data with the pre-planned trajectory data. In this example, the event insight module 314 may be further configured to identify an anomaly from the analysis by identifying an unnatural driving behavior such as a sudden lane change, a sudden road exit, or driving in the opposite direction on a map pathway.

In another example, the event insight module 314 is configured to analyze the vehicle sensing data and the pre-planned trajectory data by comparing, in the navigation module, the actual vehicle travel with the pre-planned trajectory. In this example, the event insight module 314 is further configured to identify an anomaly from the analysis by receiving a notification from the navigation module that the vehicle deviated from a navigation maneuver instruction provided by the navigation module.

In another example, the event insight module 314 is configured to analyze the vehicle sensing data and the pre-planned trajectory data by comparing map data that identifies a structural feature on the pre-planned vehicle path with perception data (e.g., lidar and/or camera data) for an actual area at which the structural feature is expected to exist. In this example, the event insight module 314 may be further configured to identify an anomaly from the analysis by identifying a disagreement between the map data and the perception data regarding the existence of the structural feature. As an example, a guard rail may not be detected by perception sensors while the map data indicates that a guard rail should be present. The example event insight map may detect the inconsistency between the map data and the vehicle experience and identify the inconsistency as an anomaly.

The example event insight module 314 includes a data filtering module 318 that may be used by the event insight module 314 to analyze the sensor data and the pre-planned trajectory data to identify an anomaly with respect to map data from the analysis. In one example use of the data filtering module 318, the example event insight module 314 is configured to analyze the vehicle sensing data and the pre-planned trajectory data by applying the data filtering module 318 with a tolerance threshold for classifying changes in the sensor data. Identifying an anomaly from the analysis, in this example, includes identifying a sudden change in the sensor data that exceeds the tolerance threshold.

In another example use of the data filtering module 318, the example event insight module 314 is configured to analyze the vehicle sensing data and the pre-planned trajectory data by applying the data filtering module 318 as a correlation function for the sensor data. Identifying an anomaly from the analysis, in this example, includes identifying an instance when the correlation between the sensor data deviates beyond a predetermined level.

The example event insight module 314 further includes a map anomaly synthesis module 320 that is configured to synthesize an anomaly message containing the sensor data and the pre-planned trajectory data related to an identified anomaly and send the anomaly message to a central repository associated with the map discrepancy detector 304.

The example map discrepancy detector 304 is a computer-implemented component that is implemented, for example by a backend server, at a location external to any of the vehicles that contain an event insight module 314. The example map discrepancy detector 304 is configured to store anomaly information from event insight modules in a central repository and analyze the anomaly information from the plurality of insight modules to determine if a reported anomaly resulted from a discrepancy in digital map data. The map discrepancy detector 304 may include an event ingestion module 322 and one or more map discrepancy determination modules 324, 326, 328.

The example event ingestion module 322 is configured to perform a message broker function for the example map discrepancy detector 304. The example message broker in the example event ingestion module 322 is configured to manage the receipt of anomaly messages from event insight modules 314. The example message broker ensures that the complete message is properly and reliably received in semi-real time and requests the retransmission of portions of the message if a complete message is not received. The example event ingestion module 322 is also configured to store received anomaly messages in a central repository 330 (e.g., a relational database). The received anomaly messages are organized by anomaly type and the location at which the anomaly occurred so that anomaly messages related to the same data discrepancy may be analyzed together.

The one or more map discrepancy determination modules 324, 326, 328 may include a concatenated rule synthesis based determination module 324, a support vector machine (SVM) descriptor and detector based determination module 326, and/or a deep learning neural network and convolutional neural network based determination module 328. The concatenated rule synthesis based determination module 324 may combine a plurality of fixed rules to determine whether an anomaly is caused by an actual map data discrepancy. The SVM descriptor and detector based determination module 326 may be formed from supervised learning models and algorithms to determine whether an anomaly is caused by an actual map data discrepancy. The deep learning neural network and convolutional neural network based determination module 328 may be formed by training a neural network using a large number of example anomaly data to train the network to determine when an anomaly is caused by an actual map data discrepancy.

The example map discrepancy detector 304 may be configured to analyze certain anomaly information only after a significant number of entities report similar anomalies in the same geographic area. This may allow the map discrepancy detector 304 to filter out anomalies that have nothing to do with map discrepancies. As an example, this may allow the map discrepancy detector 304 to filter out reported anomalies that are due to driver behavior not associated with a map discrepancy (e.g., a specific driver may not like to follow navigational instructions and a reported anomaly based on a deviation from navigational instructions can be rejected since other entities are not reporting a similar anomaly).

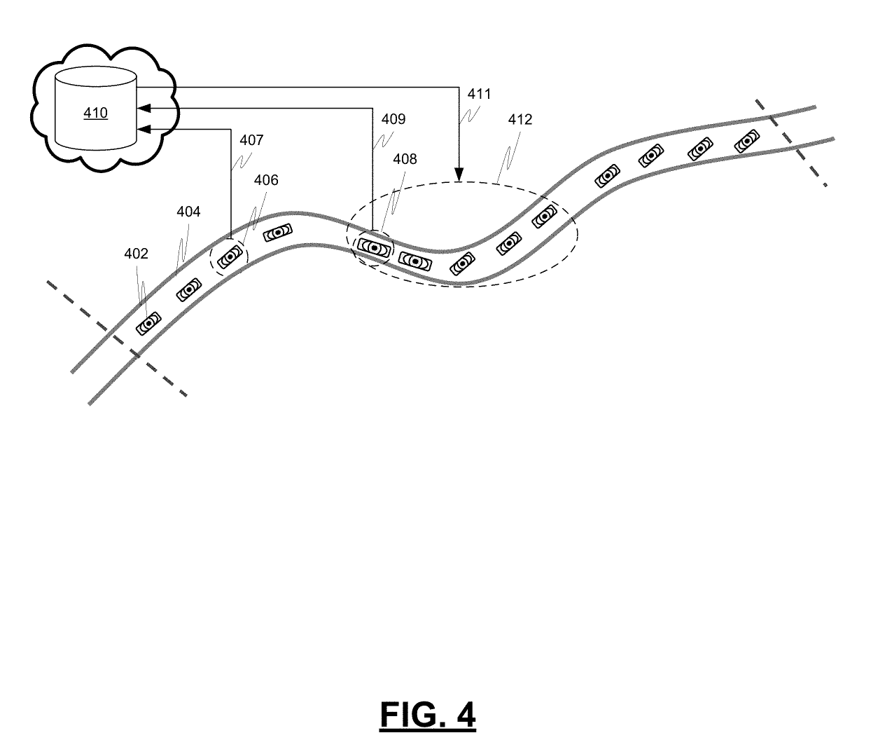

FIG. 4 presents a top-down view of an example scenario useful in understanding the present subject matter. A plurality of vehicles 402 is depicted on a roadway 404. In this example, two vehicles 406, 408 are self-reporting vehicles. The self-reporting vehicles 406, 408 may identify a map attribute anomaly and report 407, 409 the map attribute anomaly to a map discrepancy detector 410 at a backend server.

The map discrepancy detector 410 may be configured to proactively request additional data for use in determining if an anomaly indeed resulted from a map data discrepancy. In the example scenario, the map discrepancy detector 410 may have received one or more anomaly messages from vehicles reporting a similar anomaly at a specific location. To investigate the anomaly further, the example map discrepancy detector 410 may establish an extended reinforcement learning area 412. The example map discrepancy detector 410 can request 411 each vehicle in the extended reinforcement learning area 412 that is equipped with an event insight module to report 409 its planned trajectory and actual trajectory information for use by the map discrepancy detector 410 in determining if a map discrepancy actually exists. Additionally, or in the alternative, the example map discrepancy detector 410 can request 411 each vehicle in the extended reinforcement learning area 410 that is equipped with an event insight module to report 409 more detailed sensor data (e.g., GPS/CAN/Image/Radar/Lidar information) for use by the map discrepancy detector 410 in determining if a map discrepancy actually exists. In this example, one vehicle 408 in the extended reinforcement learning area 412 is equipped with an event insight module to report 409 more detailed sensor data to the map discrepancy detector 410.

In this example, the map discrepancy detector 410 is configured to direct a plurality of vehicles in an extended reinforcement learning area to report map-relevant events, including GPS/CAN/Image/Radar/Lidar information data to the map discrepancy detector 410. The map discrepancy detector 410 may be further configured to identify a correction to the defective map data for example using one or more map discrepancy determination modules that may include a concatenated rule synthesis based determination module, a SVM descriptor and detector based determination module, and/or a deep learning neural network and convolutional neural network based determination module.

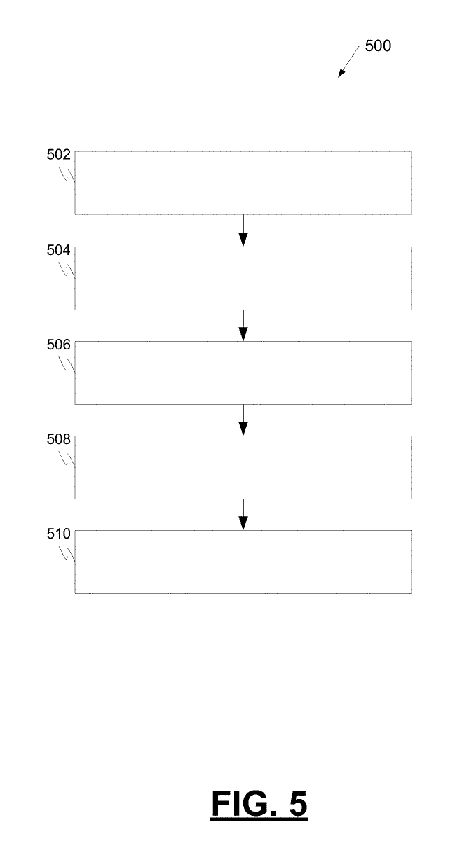

FIG. 5 is a process flow chart depicting an example process 500 in a vehicle for identifying an anomaly that may result from a map data discrepancy. The example process 500 includes receiving, by a processor in a vehicle, pre-planned trajectory data from a navigation module in the vehicle (operation 502) and retrieving, by the processor, sensor data from one or more vehicle sensing systems (operation 504). The sensor data may include vehicle performance data, vehicle perception data, and vehicle position data. The vehicle performance data may be retrieved from controller area network (CAN) signals, the vehicle perception data may be retrieved from a radar sensor, a lidar sensor, or a camera, and the vehicle position data may be retrieved from GPS data. The vehicle performance data may include vehicle velocity data, vehicle acceleration data, and vehicle yaw data.

The example process 500 further includes analyzing, by the processor, the sensor data and the pre-planned trajectory data (operation 506), identifying, by the processor, an anomaly from the analysis (operation 508), and transmitting information regarding the anomaly to a central repository external to the vehicle (operation 510). Analyzing the sensor data and the pre-planned trajectory data may include comparing actual vehicle behavior as determined by the vehicle sensing data with expected vehicle behavior based on the pre-planned trajectory data.

In one example, analyzing the sensor data and the pre-planned trajectory data includes determining actual vehicle trajectory data from the sensor data and comparing the actual trajectory data with the pre-planned trajectory data. In this example, identifying an anomaly from the analysis may include identifying a sudden lane change, a sudden road exit, or driving in the opposite direction on map pathway.

In another example, analyzing the sensor data and the pre-planned trajectory data includes comparing, in the navigation module, the actual vehicle travel with the pre-planned trajectory. In this example, identifying an anomaly from the analysis may include receiving a notification from the navigation module that the vehicle deviated from a navigation maneuver instruction provided by the navigation module.

In another example, analyzing the sensor data and the pre-planned trajectory data includes comparing map data that identifies a structural feature on the pre-planned vehicle path with perception data (e.g., lidar and/or camera data) for an actual area at which the structural feature is expected to exist. In this example, identifying an anomaly from the analysis may include identifying a disagreement between the map data and the perception data regarding the existence of the structural feature.

In another example, analyzing the sensor data and the pre-planned trajectory data includes applying a filter with a tolerance threshold for classifying changes in the sensor data. In this example, identifying an anomaly from the analysis may include identifying a sudden change in the sensor data that exceeds the tolerance threshold.

In another example, analyzing the sensor data and the pre-planned trajectory data includes applying a filter that includes a correlation function for the sensor data. In this example, identifying an anomaly from the analysis may include identifying an instance when the correlation between the sensor data deviates beyond a predetermined level.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A processor-implemented method for map anomaly detection, the method comprising:
receiving, by a processor in a vehicle, pre-planned trajectory data from a navigation module in the vehicle;
retrieving, by the processor, sensor data from one or more vehicle sensing systems;
analyzing, by the processor, the sensor data and the pre-planned trajectory data;
identifying, by the processor, an anomaly from the analysis; and
transmitting information regarding the anomaly to a central repository external to the vehicle;
wherein the central repository is configured to analyze the information regarding the anomaly to determine if a navigation map attribute is incorrect.

2. The method of claim 1, wherein the sensor data comprises vehicle performance data, vehicle perception data, and vehicle position data.

3. The method of claim 2, wherein the vehicle performance data is retrieved from controller area network (CAN) signals, the vehicle perception data is retrieved from a radar sensor, a lidar sensor, or a camera, and the vehicle position data is retrieved from GPS data.

4. The method of claim 2, wherein the vehicle performance data comprises vehicle velocity data, vehicle acceleration data, and vehicle yaw data.

5. The method of claim 1, wherein analyzing the sensor data and the pre-planned trajectory data comprises:
determining actual vehicle trajectory data from the sensor data; and
comparing the actual trajectory data with the pre-planned trajectory data.

6. The method of claim 5, wherein identifying an anomaly from the analysis comprises identifying a sudden lane change, a sudden road exit, or driving in the wrong direction on a map pathway.

7. The method of claim 1, wherein analyzing the sensor data and the pre-planned trajectory data comprises comparing, in the navigation module, actual vehicle travel with the pre-planned trajectory data.

8. The method of claim 7, wherein identifying an anomaly from the analysis comprises receiving a notification from the navigation module that the vehicle deviated from a navigation maneuver instruction provided by the navigation module.

9. The method of claim 1, wherein analyzing the sensor data and the pre-planned trajectory data comprises comparing map data that identifies a structural feature on a pre-planned vehicle path with perception data for an actual area at which the structural feature is expected to exist.

10. The method of claim 9, wherein identifying an anomaly from the analysis comprises identifying a disagreement between the map data and the perception data regarding the existence of the structural feature.

11. The method of claim 1, wherein analyzing the sensor data and the pre-planned trajectory data comprises applying a filter with a tolerance threshold for classifying changes in the sensor data.

12. The method of claim 11, wherein identifying an anomaly from the analysis comprises identifying a sudden change in the sensor data that exceeds the tolerance threshold.

13. The method of claim 1, wherein analyzing the sensor data and the pre-planned trajectory data comprises applying a filter that includes a correlation function for the sensor data.

14. The method of claim 13, wherein identifying an anomaly from the analysis comprises identifying an instance when the correlation between the sensor data deviates beyond a predetermined level.

15. The method of claim 1, wherein analyzing the sensor data and the pre-planned trajectory data comprises comparing actual vehicle behavior as determined by the sensor data and expected vehicle behavior based on the pre-planned trajectory data.

16. A system for determining digital map discrepancies, the system comprising a discrepancy detector module that comprises one or more processors configured by programming instructions encoded in non-transient computer readable media, the discrepancy detector module configured to:
store anomaly information received from a plurality of insight modules in a central repository, wherein each insight module is located in a different vehicle remote from the discrepancy detector module, each insight module comprising one or more processors configured by programming instructions encoded in non-transient computer readable media, each insight module configured to identify a map anomaly by comparing map data from a navigation module to vehicle sensor data; and
analyze the anomaly information from the plurality of insight modules to determine if a reported anomaly resulted from a discrepancy in digital map data.

17. The system of claim 16, wherein the discrepancy detector module comprises an event ingestion module that is configured to:
manage the receipt of anomaly messages from the event insight modules so that complete messages are received; and
store the received anomaly messages in a relational database in the central repository wherein the received anomaly messages are organized by type of anomaly and location at which the anomaly occurred.

18. The system of claim 16, wherein the discrepancy detector module comprises one or more map discrepancy determination modules that include one or more of a concatenated rule synthesis based determination module, a support vector machine (SVM) descriptor and detector based determination module, and a deep learning neural network and convolutional neural network based determination module.

19. The system of claim 16, wherein the discrepancy detector module is further configured to request additional data for use in determining if a reported anomaly resulted from a discrepancy in digital map data by establishing an extended reinforcement learning area wherein each vehicle located in the extended reinforcement learning area that is equipped with an event insight module is directed to report planned trajectory information, actual trajectory information, and sensor data to the discrepancy detector module.

20. A system for determining digital map discrepancies, the system comprising:
a plurality of insight modules that comprise one or more processors configured by programming instructions encoded in non-transient computer readable media, each insight module located in a different vehicle, each insight module configured to receive pre-planned trajectory data from a navigation module in its vehicle, retrieve sensor data from one or more vehicle sensing systems, analyze the sensor data and the pre-planned trajectory data, identify an anomaly from the analysis, and transmit information regarding the anomaly to a central repository external to the vehicle; and
a discrepancy detector module located remotely from the plurality of insight modules, the discrepancy detector module comprising one or more processors configured by programming instructions encoded in non-transient computer readable media, the discrepancy detector module configured to store anomaly information received from the plurality of insight modules in the central repository and analyze the anomaly information from the plurality of insight modules to determine if a reported anomaly resulted from a discrepancy in digital map data.
